(19) United States
(12) Patent Application Publication
(10) Pub. No.: US 2008/0281582 A1
(43) Pub. Date: Nov. 13, 2008

(54) Input system for mobile search and method therefor

(75) Inventors: Tien-ming Hsu, Taipei (TW); Ming-hong Wang, Hsinchu (TW); Yuan-chia Lu, Hualien (TW); Jia-lin Shen, Taipei (TW)

Correspondence Address: Haverstock & Owens LLP, 162 North Wolfe Road, Sunnyvale, CA, 94086, US

(73) Assignee: Delta Electronics, Inc.

(21) Appl. No.: 11/906,498

(22) Filed: Oct. 1, 2007

(30) Foreign Application Priority Data
May 11, 2007 (TW) 096116956

(51) Int. Cl. G10L 15/06; G06F 17/30; G10L 15/08; G06F 7/06

(52) U.S. Cl. 704/10; 704/251; 707/5; 704/E15.007; 707/E17.071

(57) ABSTRACT

An input system for mobile search and a method therefor are provided. The input system includes an input module receiving a code input for a specific term and a voice input corresponding thereto, a database including a glossary and an acoustic model, wherein the glossary includes a plurality of terms and a sequence list, and each of the terms has a search weight based on an order of the sequence list, a process module selecting a first number of candidate terms from the glossary according to the code input by using an input algorithm and obtaining a second number of candidate terms by using a speech recognition algorithm to compare the voice input with the first number of candidate terms via the acoustic model, wherein the second number of candidate terms are listed in a particular order based on their respective search weights, and an output module showing the second number of candidate terms in the particular order for selecting the specific term therefrom.

### FIELD OF THE INVENTION

The present invention is related to an input system and a method therefor, and more particularly to an input system for mobile search and a method therefor to input a specific term.

### BACKGROUND OF THE INVENTION

The present text input method for the mobile communication device is still inconvenient to the user. In the conventional input method, the user may press many keys for inputting an alphabetic symbol or a phonetic symbol.

With regard to the recently popular associated input method, such as T9, for inputting each alphabetic symbol or phonetic symbol, a user only needs to press at least one key. Then the resultant English words or Chinese words are the possible combinations found out by the method of searching the dictionary and listed to provide the choices for the user.

Please refer to FIG. 1, which is a schematic view showing a conventional text input keyboard of a mobile phone for Nokia. The text input keyboard 10 includes a plurality of digital keys, in which each of digital keys has a corresponding alphabetic symbol or phonetic symbol shown in FIG. 1, so that the user could use the associated input method to input a term via the text input keyboard 10. For example, the English word “me” would be inputted by pressing digital keys of 6 and 3 and the “select” key (not shown), and the Chinese term [symbol] which includes their corresponding phonetic symbols of [symbol] and [symbol] would be inputted by pressing digital keys of 2, 0 and 9 and the “select” key and then pressing digital keys of 3, 0 and 9 and the “select” key. When the “*” key is pressed, plural common specific symbols are shown for the user to select, and when the “#” key is pressed, different input methods can be changed, such as the Chinese input method (phonetic symbols) is changed to the English input method (alphabetic symbols/ciphers).

Please refer to FIG. 2, which is a flow chart showing the conventional associated input method, such as T9. Firstly, a key is pressed once for inputting an alphabetic symbol or a phonetic symbol (step 20). That is, a user keys in an English letter or a Chinese phonetic symbol for inputting a word, which could be an English word or a Chinese word. The complete input for the phonetic symbols is applied to search candidate words from a dictionary corresponding to the desired Chinese word. Further, it is determined whether the step 20 is complete (step 21). If the step 20 is complete, the dictionary could be inquired to list at least one candidate words (step 22). That is to say, the at least one candidate words of the desired word is obtained by inquiring the dictionary based on the complete inputted alphabetic symbols, ciphers, or phonetic symbols for listing the at least one candidate words of the desired word in a predetermined order, e.g. sorting the at least one candidate words in a order according to the usage frequency for each word. However, if it is determined that the step 20 is not complete in the step 21, it will return to the step 20. After processing the step 22, the step 23 is processed by pressing the controlling keys, such as the up key or the down key, for selection. That is, the user can select the right word by using the controlling keys if the first listed candidate word in the predetermined order is not the desired word. Of course, if the first listed candidate word is the desired word, the user can select it directly.

The method makes the input process simpler and allows the user to find out the desired term by pressing fewer keys. However, if there are many possible combinations and the first listed candidate word is not the desired word, the user still has to select the desired word by pressing the controlling keys. For example, the candidate words would be “of, me . . . etc.” by pressing digital keys of 6 and 3, the candidate words would be [symbol] . . . etc.” by pressing digital keys of 2, 0 and 9, and the candidate words would be [symbol] . . . etc.” by pressing digital keys of 3, 0 and 9.

Thus, while the English word “me” would be inputted, the user needs to press the digital keys of 6 and 3 and then press the “down” key once. Further, while the Chinese term [symbol] would be inputted, the user needs to press the digital keys of 2, 0 and 9, the “down” key three times, the digital keys of 3, 0 and 9, and then the “down” key four times. Moreover, when the user wants to input words for English, Chinese and ciphers at the same time, the input methods would be manually switched, which is also inconvenient.

Besides, mobile search is the top network application in the current mobile communication. However, it is quite difficult to input keywords quickly based on the mentioned conventional input methods.

Therefore, the purpose of the present invention is to develop an input system for mobile search and a method therefor to deal with the above situations encountered in the prior art.

### SUMMARY OF THE INVENTION

It is therefore a first aspect of the present invention to provide an input system for mobile search and a method therefor having a diversified input forms to decrease the keying number for input a keyword and using a speech recognition to select possible candidate term, thereby providing a keyword input interface with more convenient and faster.

It is therefore a second aspect of the present invention to provide an input system for mobile search and a method therefor to update dynamically respective terms of a glossary and a sequence list for the respective terms based on the current network search frequency statistic, so as to meet the need for mobile search.

According to a third aspect of the present invention, an input system for mobile search is provided. The input system includes an input module receiving a code input for a specific term and a voice input corresponding to the specific term, a database including a glossary and an acoustic model, wherein the glossary includes a plurality of terms and a sequence list for the plurality of terms, and each of the plurality of terms has a search weight based on an order of the sequence list, a process module selecting a first number of candidate terms from the glossary according to the code input by using an input algorithm and obtaining a second number of candidate terms by using a speech recognition algorithm to compare the voice input with the first number of candidate terms via the acoustic model, wherein the second number of candidate terms are listed in a particular order based on their respective search weights, and an output module showing the second number of candidate terms in the particular order for selecting the specific term therefrom.

Preferably, the order of the sequence list for the respective terms is provided by a statistic of a usage frequency of the respective terms, and the term having the most usage frequency is given a biggest numeral for the search weight and listed in a top of the sequence list.

Preferably, the order of the sequence list for the respective term could be provided by a network search frequency statistic for the respective terms in a server, and the term having the most network search frequency is given a biggest numeral for the search weight and listed in a top of the sequence list. Thus, the input system further includes a communication module communicating with an updated database of the server through a linked network to update the respective terms of the glossary and the sequence list therefor.

Preferably, the updated database gives each of the updated terms a new search weight based on their respective search and usage frequencies in the server during a desire period, so as to update the glossary and the sequence list for the respective terms.

Preferably, the server further includes a network glossary having a plurality of terms more than those in the glossary of the database.

Preferably, the process module is connected to the communication module for selecting corresponding candidate terms from the network glossary according to the code input while no candidate term in the glossary of the database is matched with the code input.

Preferably, the input algorithm is an associated input characters algorithm and the term is a keyword of a text and the code input includes at least one input code for a part of the keyword.

Preferably, the code input is one selected from the group consisting of a phonetic symbol, a stroke symbol, an alphabetic symbol, a radical symbol, a tone symbol, a cipher and a plurality of common special symbols.

Preferably, the text is one selected from the group consisting of a Chinese word, a Japan word, a Korean word, an English word, a German word, a French word, a Spanish word, an Arabic word, a Russian word, an Italic word, a Portuguese word, a Netherlands word, a Greek word, a Czech word and a Denmark word.

Preferably, the particular order is further arranged according to respective similarity weights for the second number of candidate terms obtained by the speech recognition algorithm comparing the first number of candidate terms with the voice.

According to a fourth aspect of the present invention, an input method for mobile search to input a specific term is provided. The input method includes steps of (a) providing a database having a glossary, wherein the glossary includes a plurality of terms and a sequence list for the plurality of terms, and each of the plurality of terms has a search weight based on an order of the sequence list, (b) inputting at least one code of the specific term according to an input method, (c) selecting a first number of candidate terms from the glossary according to the code, (d) inputting a voice, (e) performing a speech recognition for the voice and obtaining a second number of candidate terms by comparing the voice with the first number of candidate terms for generating respective similarity weights for the second number of candidate terms, wherein the second number of candidate terms are listed in a particular order based on their respective search weights and respective similarity weights, and (f) showing the second number of candidate terms in the particular order for selecting the specific term therefrom.

Preferably, the input method further includes steps of (g) providing a network glossary to search more candidate terms via a linked network while no candidate term in the glossary of the database is matched with the code, and (h) updating the terms of the glossary and the sequence list in the database via a linked network.

Preferably, the input method is an associated input method.

According to a fifth aspect of the present invention, an input system for mobile search to input a specific term is provided. The input system includes an input module a code input for a specific term and a voice input corresponding to the specific term, a glossary having a plurality of terms and a sequence list for the plurality of terms, and each of the plurality of terms includes a search weight based on an order of the sequence list, a process module selecting a first number of candidate terms from the glossary according to the code input by using an input algorithm and obtaining a second number of candidate terms by using a speech recognition algorithm to compare the voice with the first number of candidate terms for generating respective similarity weights of the respective second number of candidate terms, wherein the second number of candidate terms are listed in a particular order based on their respective search weights and respective similarity weights, and an output module showing the second number of candidate terms in the particular order for selecting the specific term therefrom.

According to a sixteenth aspect of the present invention, a process method for mobile search in a mobile communication device to input a specific term is provided. The process method includes steps of receiving a first input, wherein the first input includes at least one code of the specific term, determining a first number of candidate terms based on the first input, receiving a second input including a voice, determining a second number of candidate terms according to the first input and the second input, wherein each of the second number of candidate terms has at least one weight obtained from one of the first input and the second input, and selecting the specific term according to their respective weights.

Preferably, the process method further includes a step of sorting the second number of candidate terms in a particular order based on their respective weights.

Preferably, the weight is a search weight and a similarity weight.

Preferably, the first input is one selected from the group consisting of a touch input, a handwriting recognition input and a keyboard entry.

Preferably, the second number of candidate terms are determined based on the second input under the first input.

Preferably, the first number of candidate terms are determined according to a context corresponding to the first input.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic view showing a conventional text input keyboard of a mobile phone;

FIG. 2 is a flow chart showing the conventional associated input method;

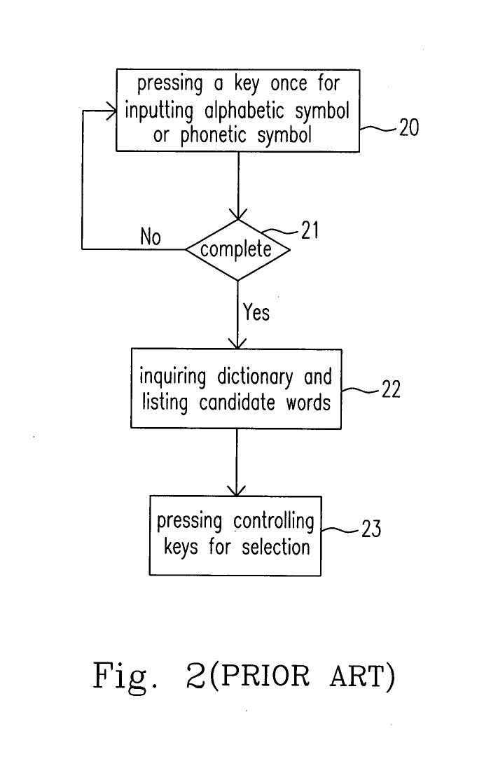

FIG. 3 is a schematic view showing an input system for mobile search and a method therefor according to a preferred embodiment of the present invention;

FIG. 4 is a flow chart showing an input system for mobile search and a method therefor according to the preferred embodiment of the present invention; and

FIG. 5 is a flow chart showing a process method for mobile search in a mobile communication device according to the preferred embodiment of the present invention.

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purposes of illustration and description only; it is not intended to be exhaustive or to be limited to the precise form disclosed.

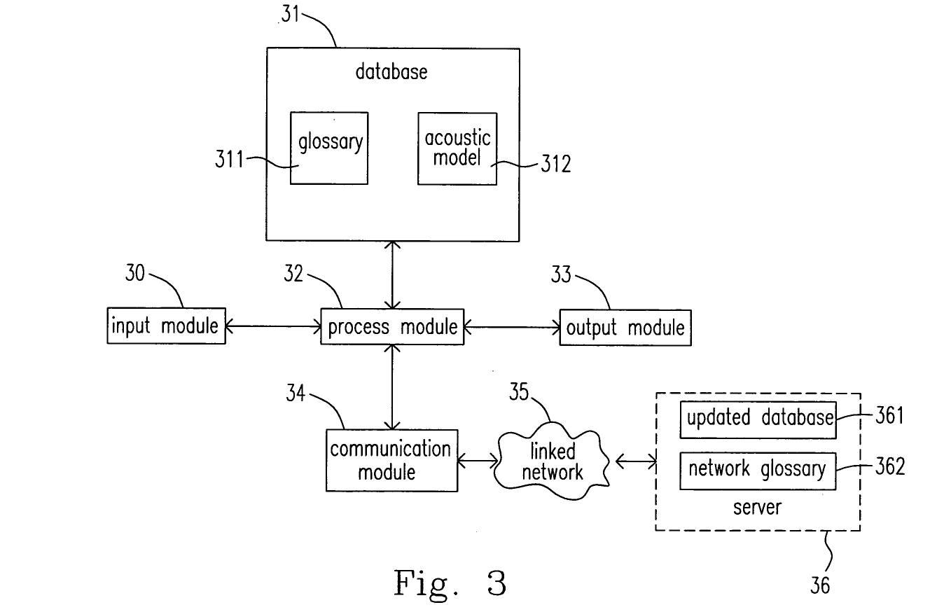

Please refer to FIG. 3, which is a schematic view showing an input system for mobile search and a method therefor according to a preferred embodiment of the present invention. The present input system includes an input module 30, a database 31, a process module 32 and an output module 33.

The input module 30 is used for receiving at least one code input for a specific term and a voice input corresponding to the specific term by a user. The database 31 includes a glossary 311 and an acoustic model 312, in which the glossary 311 includes a plurality of terms and a sequence list for the plurality of terms, and each of the plurality of terms has a search weight based on an order of the sequence list. Further, the process module 32 includes an input algorithm and a speech recognition algorithm. Thus, a first number of candidate terms would be selected from the glossary 311 according to the code input by using the input algorithm. In addition, a second number of candidate terms would be obtained by using the speech recognition algorithm to compare the voice input with the first number of candidate terms via the acoustic model 312. Besides, respective similarity weights for the respective second number of candidate terms are further generated thereby. Moreover, the respective second number of candidate terms of candidate terms also has the respective search weights since the glossary 311 provides each of the plurality of terms with its search weight. The second number of candidate terms are listed in a particular order based on the proper radio of their respective search weights and respective similarity weights. For example, the particular order is mainly based on their similarity weights and one of the candidate terms with the same similarity weight would be arranged in the front of the particular order according to its higher search weight. Accordingly, the output module 33 can show the second number of candidate terms in the particular order for selecting the specific term therefrom.

Furthermore, the order of the sequence list for the respective terms is provided by a statistic of a personal usage frequency of the respective terms, and the term having the most personal usage frequency is given a biggest numeral for the search weight and listed in a top of the sequence list. Besides, the order of the sequence list for the respective term is also provided by a network search frequency statistic for the respective terms, and the term having the most network search frequency is given a biggest numeral for the search weight and listed in a top of the sequence list. Further, the statistic of the personal usage frequency and the network search frequency statistic could be integrated to arrange the order of the sequence list for the respective terms. For example, there are five terms with Top 5 candidate terms of the personal usage frequency in a front order of the sequence list and there are five terms with Top 5 of the network search frequency in a later order of the sequence list. Similarly, the sequence list would be the order of the alternated candidate terms for the personal usage frequency and the network search frequency statistic.

Thus, the present input system further includes a communication module 34 communicating with a server 36 through a linked network 35. The server 36 includes an updated database 361 and a network glossary 362. The updated database 361 gives each of the updated terms a new search weight based on their respective search and usage frequencies in the server 36 during a desire period, so as to update the glossary 361 and the sequence list for the respective terms. Thus, the process module 36 could be connected to the updated database 361 of the server 36 through the communication module 34 to update the respective terms of the glossary 361 and the sequence list therefor.

Moreover, the network glossary 362 has a plurality of terms more than those in the glossary 311 of the database 31. While no candidate term in the glossary 311 is matched with the code input, the process module 36 could be connected to the communication module 34 for selecting corresponding candidate terms from the network glossary 361 via the linked network 35 according to the code input.

In addition, the input algorithm is an associated input characters algorithm to show a plurality of associated candidate terms based on different corresponding code inputs. The term is a keyword of a text. The text is one selected from the group consisting of a Chinese word, a Japan word, a Korean word, an English word, a German word, a French word, a Spanish word, an Arabic word, a Russian word, an Italic word, a Portuguese word, a Netherlands word, a Greek word, a Czech word and a Denmark word. Further, the code input includes at least one input code for a part of the keyword, and the code input is one selected from the group consisting of a phonetic symbol, a stroke symbol, an alphabetic symbol, a radical symbol, a tone symbol, a cipher and a plurality of common special symbols.

The present invention is applied for mobile search to input a keyword. Thus, the number of times for the code input would be reduced according to the present invention since there are respective limited amounts for the terms in the glossary 311 and the network glossary 362. The keyword is often composed of at least two separate words. Further, the firs number of candidate terms could be selected by initial input code of respective separate words of the keyword or at least two input codes for a part of the keyword without the complete input codes therefor. Then, the second number of candidate terms would be obtained by the voice input for the keyword. It is not difficult for selecting the desired keyword for the user because of the voice input, i.e. the subsequent speech recognition process, even though there are more candidate terms are selected by the less input codes for the keyword. In addition, it includes a stable accuracy for the speech recognition process in the present invention. Besides, the respective search weights for the candidate terms would be applied to the mentioned speech recognition process. Since a term with a relatively high search weights means the term having a more common usage frequency or search frequency, it would be more easily determined for the term with the relatively high search weights by weighting the term during the speech recognition process, so as to meet the use for mobile search.

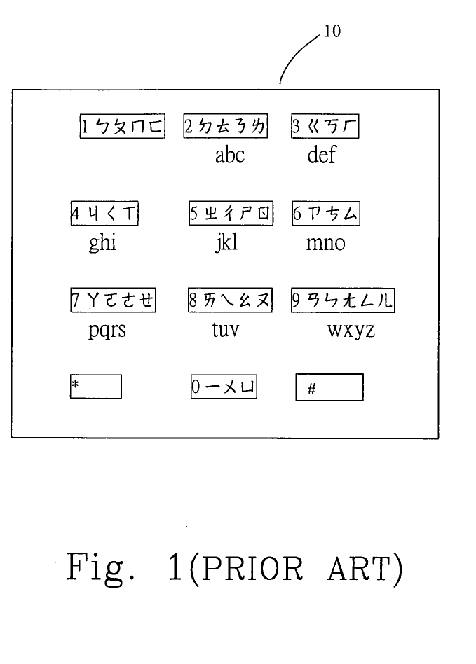

Accordingly, the present invention would be implemented by the text input keyboard 10 in FIG. 1. While the Chinese term [symbol] would be inputted by the code input with the phonetic symbol, such term would be shown by pressing the digital keys of 2 and 3, i.e. the phonetic symbols of [symbol] and [symbol] and then providing a voice input of [symbol] Further, the code input could be other input method, such as the stroke symbol, the alphabetic symbol, the radical symbol, the tone symbol, the cipher or other common special symbols. Accordingly, while the Chinese term [symbol] would be inputted by the code input with the tone symbol, such term could be shown by pressing the digital keys of 1 and 1, i.e. the tone symbols of “Tone 1” and “Tone 1”, and then providing the voice input of [symbol] While the Chinese term [symbol] would be inputted by the code input with the alphabetic symbol, such term could be shown by pressing the digital keys of 8 and 5, i.e. the alphabetic symbols of “T” and “K” and then providing the voice input of [symbol] Besides, the present invention further provides the input method by inputting the code input for a part of the keyword, such as the keyword includes five words and the user can input the code input for two words therein. For example, while the Chinese term [symbol] would be inputted, the user only presses the digital keys of 2 and 1, i.e. the phonetic symbols of [symbol] and [symbol] and then speak the voice input of [symbol] When the English term “Delta” would be inputted, the user can press the digital keys of 3 and 3, i.e. the alphabetic symbols of “D” and “E” and then speak the voice input of “Delta”.

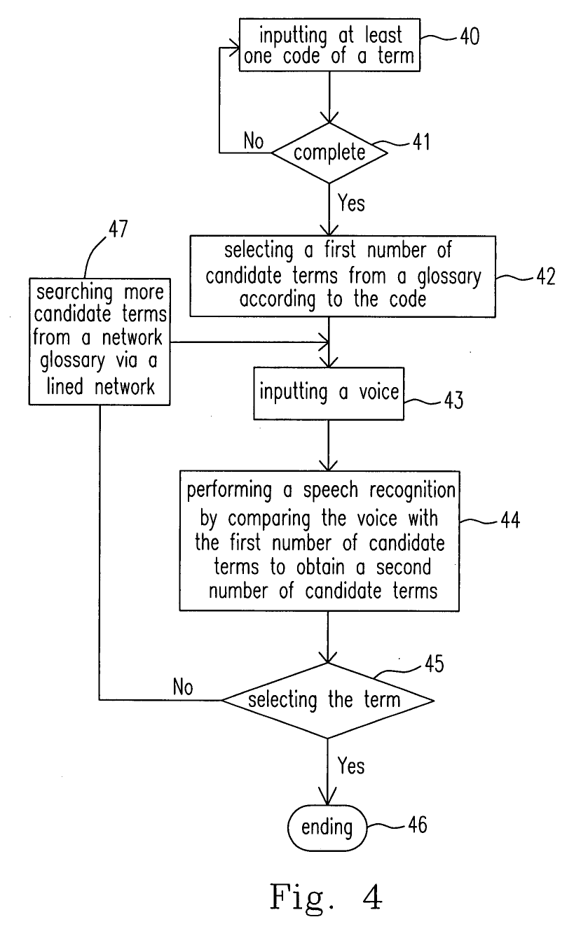

Please refer to FIG. 4, which is a flow chart showing an input system for mobile search and a method therefor according to the preferred embodiment of the present invention. The present method includes a database having a glossary, wherein the glossary includes a plurality of terms and each of the plurality of terms has a search weight. Firstly, at least one code of a desired term according to an input method would be inputted (step 40). Further, it is determined whether the step 40 is complete (step 41). Then, a first number of candidate terms according to the code would be selected from the glossary (step 42). The voice for the specific term would be inputted (step 43). Moreover, it would be performed for the speech recognition by comparing the voice with the first number of candidate terms to obtain a second number of candidate terms (step 44). Thus, respective similarity weights for the second number of candidate terms would be generated thereby. In addition, the second number of candidate terms are listed for selecting the desired term therefrom (step 45). Finally, the present method is ended (step 46).

Besides, if the desired term cannot be selected form the second number of candidate terms in the step 45, i.e. no candidate term in the glossary of the database is matched with the code, a network glossary is further provided to search more candidate terms via a linked network (step 47). Then, the step 43, the step 44 and the step 45 are performed repeatedly and more candidate terms would be shown to select again.

According to the above description, each of candidate terms includes its search weigh and the respective similarity weights for the candidate terms is generated after performing the speech recognition. Based on the their respective search weights and respective similarity weights, the second number of candidate terms are arranged in a particular order based on their respective search weights and respective similarity weights. Thus, the most searched term could be listed in a top of the particular order to meet the need for mobile search.

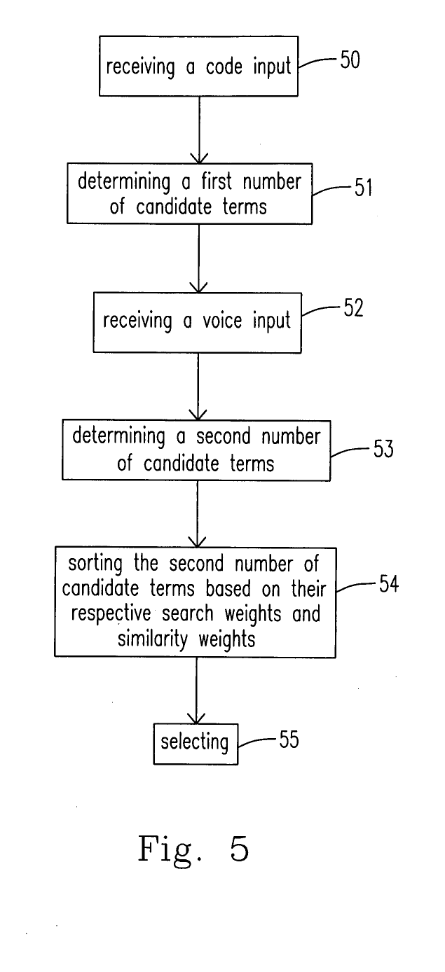

Please refer to FIG. 5, which is a flow chart showing a process method for mobile search in a mobile communication device according to the preferred embodiment of the present invention. The present invention could be applied to the mobile communication device. Firstly, the mobile communication device would receive a first input (step 50), in which the first input is a code input having at least one code of a desired term. Further, a first number of candidate terms would be determined based on the code input (step 51). Then, the mobile communication device can receive a second input (step 52), which the second input is a voice input having a voice. In addition, a second number of candidate terms would be determined according to the code input and the voice input (step 53). Each of the second number of candidate terms has at least one weight obtained from one of the first input and the second input, so that the second number of candidate terms would be sorted in a particular order based on their respective weights, i.e. the search weight and the similarity weight (step 54). Finally, the desired term would be selected from the sorted second number of candidate terms.

Moreover, the code input is one selected from the group consisting of a touch input, a handwriting recognition input and a keyboard entry. The second number of candidate terms are determined based on the voice input under the code input, that is, the speech recognition is performed by comparing the voice input with the first number of candidate terms. Since the present process method is based on an associated input method, the first number of candidate terms are determined according to a contest corresponding to the code input.

As we know, the conventional input method has to input complete codes for every word of the keyword one by one and respectively selecting the proper candidate words. According the above description, it would be understood that the present input system for mobile and the present method therefor provide a characteristic keyword input interface to effectively simply the conventional input process and remain certain accuracy. Accordingly, the present invention is suitable for the application of mobile search. Further, the terms of the glossary and the sequence list for the respective terms based on the current network search frequency statistic would be updated dynamically by the present invention, so as to meet the need for mobile search.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input system for mobile search, comprising:
an input module receiving a code input for a specific term and a voice input corresponding to the specific term;
a database including a glossary and an acoustic model, wherein the glossary includes a plurality of terms and a sequence list for the plurality of terms, and each of the plurality of terms has a search weight based on an order of the sequence list;
a process module selecting a first number of candidate terms from the glossary according to the code input by using an input algorithm and obtaining a second number of candidate terms by using a speech recognition algorithm to compare the voice input with the first number of candidate terms via the acoustic model, wherein the second number of candidate terms are listed in a particular order based on their respective search weights; and
an output module showing the second number of candidate terms in the particular order for selecting the specific term therefrom.

2. The input system according to claim 1, wherein the order of the sequence list for the respective terms is provided by a statistic of a usage frequency of the respective terms, and the term having the most usage frequency is given a biggest numeral for the search weight and listed in a top of the sequence list.

3. The input system according to claim 1, wherein the order of the sequence list for the respective term is provided by a network search frequency statistic for the respective terms in a server, and the term having the most network search frequency is given a biggest numeral for the search weight and listed in a top of the sequence list.

4. The input system according to claim 3, further comprising a communication module communicating with an updated database of the server through a linked network to update the respective terms of the glossary and the sequence list therefor.

5. The input system according to claim 4, wherein the updated database gives each of the updated terms a new search weight based on their respective search and usage frequencies in the server during a desire period, so as to update the glossary and the sequence list for the respective terms.

6. The input system according to claim 4, wherein the server further comprises a network glossary having a plurality of terms more than those in the glossary of the database.

7. The input system according to claim 6, wherein the process module is connected to the communication module for selecting corresponding candidate terms from the network glossary according to the code input while no candidate term in the glossary of the database is matched with the code input.

8. The input system according to claim 1, wherein the input algorithm is an associated input characters algorithm.

9. The input system according to claim 8, wherein the term is a keyword of a text and the code input comprises at least one input code for a part of the keyword.

10. The input system according to claim 9, wherein the code input is one selected from the group consisting of a phonetic symbol, a stroke symbol, an alphabetic symbol, a radical symbol, a tone symbol, a cipher and a plurality of common special symbols.

11. The input system according to claim 9, wherein the text is one selected from the group consisting of a Chinese word, a Japan word, a Korean word, an English word, a German word, a French word, a Spanish word, an Arabic word, a Russian word, an Italic word, a Portuguese word, a Netherlands word, a Greek word, a Czech word and a Denmark word.

12. The input system according to claim 1, wherein the particular order is further arranged according to respective similarity weights for the second number of candidate terms obtained by the speech recognition algorithm comparing the first number of candidate terms with the voice.

13. An input method for mobile search to input a specific term, comprising steps of:
(a) providing a database having a glossary, wherein the glossary includes a plurality of terms and a sequence list for the plurality of terms, and each of the plurality of terms has a search weight based on an order of the sequence list;
(b) inputting at least one code of the specific term according to an input method;
(c) selecting a first number of candidate terms from the glossary according to the code;
(d) inputting a voice;
(e) performing a speech recognition for the voice and obtaining a second number of candidate terms by comparing the voice with the first number of candidate terms for generating respective similarity weights for the second number of candidate terms, wherein the second number of candidate terms are listed in a particular order based on their respective search weights and respective similarity weights; and
(f) showing the second number of candidate terms in the particular order for selecting the specific term therefrom.

14. The input method according to claim 13, further comprising a step of (g) providing a network glossary to search more candidate terms via a linked network while no candidate term in the glossary of the database is matched with the code.

15. The input method according to claim 13, further comprising a step of (h) updating the terms of the glossary and the sequence list in the database via a linked network.

16. The input method according to claim 13, wherein the input method is an associated input method.

17. An input system for mobile search to input a specific term, comprising:
an input module a code input for a specific term and a voice input corresponding to the specific term;
a glossary having a plurality of terms and a sequence list for the plurality of terms, and each of the plurality of terms includes a search weight based on an order of the sequence list;
a process module selecting a first number of candidate terms from the glossary according to the code input by using an input algorithm and obtaining a second number of candidate terms by using a speech recognition algorithm to compare the voice with the first number of candidate terms for generating respective similarity weights of the respective second number of candidate terms, wherein the second number of candidate terms are listed in a particular order based on their respective search weights and respective similarity weights; and
an output module showing the second number of candidate terms in the particular order for selecting the specific term therefrom.

18. A process method for mobile search in a mobile communication device to input a specific term, comprising steps of:
receiving a first input, wherein the first input comprises at least one code of the specific term;
determining a first number of candidate terms based on the first input;
receiving a second input including a voice;
determining a second number of candidate terms according to the first input and the second input, wherein each of the second number of candidate terms has at least one weight obtained from one of the first input and the second input; and
selecting the specific term according to their respective weights.

19. The process method according to claim 18 further comprising a step of sorting the second number of candidate terms in a particular order based on their respective weights.

20. The process method according to claim 18, wherein the weight is a search weight and a similarity weight.

21. The process method according to claim 18, wherein the first input is one selected from the group consisting of a touch input, a handwriting recognition input and a keyboard entry.

22. The process method according to claim 18, wherein the second number of candidate terms are determined based on the second input under the first input.

23. The process method according to claim 18, wherein the first number of candidate terms are determined according to a context corresponding to the first input.
